(19) United States
(12) Patent Application Publication
(10) Pub. No.: US 2007/0018564 A1
(43) Pub. Date: Jan. 25, 2007

(54) Electron emission type backlight unit, flat panel display device having the same, and method of driving the electron emission unit

(76) Inventors: Young-Suk Cho, Suwon-si (KR); Yong-Soo Choi, Suwon-si (KR); Jae-Woo Bae, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 11/489,432

(22) Filed: Jul. 20, 2006

(30) Foreign Application Priority Data
Jul. 21, 2005 (KR) 10-2005-0066382

(51) Int. Cl. H01J 63/04; H01J 1/62

(52) U.S. Cl. 313/496

(57) ABSTRACT

An electron emission type backlight unit may include a front substrate and a rear substrate facing each other with a predetermined distance between them, an anode and a fluorescent layer disposed between the front substrate and the rear substrate, first electrodes and second electrodes disposed between the front substrate and the rear substrate, electron emitting layers partially or entirely covering at least one of the first and second electrodes, and secondary electron emitting layers covering the electron emitting layers, and a flat panel device having the same, and a method of driving the electron emission type backlight unit.

### BACKGROUND OF THE INVENTION

1. Field of the Invention

The present invention relates to an electron emission unit and a flat panel display device employing the electron emission unit. More particularly, the present invention relates to an electron emission unit which may effectively block the effect of an anode field and may improve the efficiency of electron emission from second electrodes. The present invention also relates to a flat panel display device employing the electron emission unit as a backlight unit and a method for driving the electron emission unit.

2. Description of the Related Art

In general, flat panel display devices may be classified into emissive display devices and non-emissive display devices. Examples of the emissive display devices include, but are not limited to, a cathode ray tube (CRT), a plasma display panel (PDP), and a field emission display (FED). An example of the non-emissive display device includes, but is not limited to, a liquid crystal display (LCD).

Among these examples, the LCD may be of light weight and low power consumption. However, the LCD is a non-emissive display device and thus any image produced is due to external light. Accordingly, the LCD may include a light unit, which may be located at a rear side, to emit light. When using the backlight unit, the LCD may be used in a dark place.

While there may be different backlight units, a linear light source and a point light source may be used as an edge type backlight unit. Particularly, a cold cathode fluorescent lamp (CCFL) having electrodes at both ends of a tube is commonly used as a linear light source. A light emitting diode (LED) is commonly used as a point light source. The CCFL may offer strong white light generation, superior brightness, uniformity and easy large-scale design. However, the CCFL may operate using a high frequency alternating current. Additionally, the CCFL may operate within a narrow temperature range.

The LED may operate with less brightness and uniformity than the CCFL. This may be especially true in a larger LED. Also, high power may be consumed when reflecting and transmitting light due to the light source being located on a rear side. Further, the structural complexities of a LED may result in higher production costs. Nevertheless, the LED may operate using direct current instead of a high frequency alternating current. Additionally, the LED may offer improved power and temperature characteristics, small size and longer life expectancy.

Recently, electron emission units employed as backlight units and using a planar light emitting structure have been proposed to solve the above problems. Such backlight units may exhibit lower power consumption and more uniform brightness, even over wider regions, as compared to a CCFL or the like.

An electron emission type backlight unit employing a planar light emitting structure may have a front substrate and a rear substrate that may be separated from each other by a predetermined gap. An anode and a fluorescent layer may be sequentially disposed on a bottom surface of the front substrate, and first electrodes may be disposed on a top surface of the rear substrate and stripe-patterned electron emitting layers may be disposed on the first electrodes. In operation, a high voltage for emitting electrons may be directly applied between the anode and the first electrodes, which may cause local arcing. Due to the local arcing, uniform brightness over the entire display surface may be compromised. Furthermore, the local arcing may cause damage to the anode, the first electrodes, the fluorescent layer, and/or the electron emitting layers, thereby shortening the life of the electron emission type backlight unit.

One solution to overcome these problems is an electron emission type backlight unit which may include second electrodes. More particularly, stripe-patterned first and second electrodes may be alternately disposed, in parallel, on a top surface of the rear substrate. Electron emitting layers may partially or entirely cover both the first and the second electrodes. While in this structure, the anode and the first electrodes may not facilitate local arcing as in the previous structure, the anode may generate an anode field, which may affect an electric field that may exist between the first and second electrodes. Additionally, the anode field may cause undesirable diode radiation and it may be difficult to control electron emission from the second electrodes.

### SUMMARY OF THE INVENTION

The present invention is therefore directed to an electron emission type backlight unit, a flat panel display device having the same, and a method of driving the electron emission type unit, which substantially overcome one or more of the problems due to the limitations and disadvantages of the related art.

It is therefore a feature of an exemplary embodiment of the present invention to provide an electron emission type backlight unit, which may block an anode field and improve efficiency in electron emission, by employing secondary electron emitting layers, a flat panel display device having the electron emission type backlight unit, and a method of driving the electron emission type backlight unit.

It is therefore another feature of an exemplary embodiment of the present invention to provide an electron emission type backlight unit, which may reduce unnecessary electron emission and power consumption, by alternately arranging first and second electrodes, and alternately applying voltages to the first and second electrodes, a flat panel display device having the electron emission type backlight unit, and a method of driving the electron emission type backlight unit.

It is therefore another feature of an exemplary embodiment of the present invention to provide an electron emission type backlight unit, which may reduce manufacturing costs by eliminating unnecessary portions of the electron emission layers that do not contribute to electron emission, a flat panel display device having the electron emission type backlight unit, and a method of driving the electron emission type backlight unit.

At least one of the above and other features and advantages of the present invention may be realized by providing an electron emission type backlight unit, which may include a front substrate and a rear substrate, which may face each other with a predetermined distance between them, an anode and a fluorescent layer that may be disposed between the front substrate and the rear substrate, first electrodes and second electrodes that may be disposed between the front substrate and the rear substrate, electron emitting layers that may be partially or entirely covering at least one of the first and second electrodes, and secondary electron emitting layers that may cover the electron emitting layers.

The anode and the fluorescent layer may be sequentially stacked on a bottom surface of the front substrate facing the rear substrate.

The first electrodes and the second electrodes may be alternately arranged in parallel on a top surface of the rear substrate facing the front substrate.

The first electrodes and the second electrodes may have the same or substantially the same height.

The electron emitting layers may cover side surfaces of at least one of the first electrodes and the second electrodes.

The electron emitting layers may have the same or substantially the same height as the first electrodes and the second electrodes. The electron emitting layers may be shorter than the first electrodes and the second electrodes, so as not to be affected by an anode field.

The electron emitting layers may be separated from the rear substrate by a predetermined distance, as measured from a common reference point of the surface of the rear substrate, and extend to a height equal to or substantially equal to the top surface of at least one of the first electrodes and the second electrodes facing the front substrate.

The electron emitting layers may be separated from the rear substrate by a predetermined distance, as measured from a common reference point of the surface of the rear substrate, and extend to a height shorter than the top surface of at least one of the first electrodes and the second electrodes facing the front substrate.

The electron emission type backlight unit may further include insulating layers disposed between the rear substrate and the electron emitting layers

The electron emission type backlight unit may further include insulating layers disposed on portions between the first electrodes and the second electrodes, where the electron emitting layers may not be disposed.

The electron emitting layers may include carbon nanotubes. The secondary electron emitting layers may be MgO layers.

At least one of the above and other features and advantages of the present invention may be realized by providing a flat panel display device, which may include an electron emission type backlight unit, which may further include a front substrate and a rear substrate facing each other with a predetermined distance between them, an anode and a fluorescent layer that may be disposed between the front substrate and the rear substrate, first electrodes and second electrodes that may be disposed between the front substrate and the rear substrate, electron emitting layers that may be partially or entirely covering at least one of the first and second electrodes, secondary electron emitting layers that may cover the electron emitting layers, and a light receiving device that may be disposed in front of the electron emission type backlight unit, and may be configured to control the light provided by the electron emission type backlight unit in order to produce an image.

The anode and the fluorescent layer may be sequentially stacked on a bottom surface of the front substrate facing the rear substrate.

The first electrodes and the second electrodes may be alternately arranged in parallel on a top surface of the rear substrate facing the front substrate.

The first electrodes and the second electrodes may have the same height or substantially the same height.

The electron emitting layers may cover side surfaces of at least one of the first electrodes and the second electrodes.

The electron emitting layers may have the same height or substantially the same height as the first electrodes and the second electrodes. The electron emitting layers may be shorter than the first electrodes and the second electrodes so as not to be affected by an anode field.

The electron emitting layers may be separated from the rear substrate by a predetermined distance, as measured from a common reference point of the surface of the rear substrate, and extend to a height equal to or substantially equal to the top surface of at least one of the first electrodes and the second electrodes facing the front substrate.

The electron emitting layers may be separated from the rear substrate by a predetermined distance, as measured from a common reference point of the surface of the rear substrate, and extend to a height shorter than the top surface of at least one of the first electrodes and the second electrodes.

The flat panel display device may further include insulating layers disposed between the rear substrate and the electron emitting layers.

The flat panel display device may further include insulating layers disposed on portions between the first electrodes and the second electrodes, where the electron emitting layers may not be disposed.

The electron emitting layers may include carbon nanotubes. The secondary electron emitting layers may be MgO layers. The light receiving device may be a liquid crystal display device.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a cross-sectional view of an electron emission type backlight unit according to an exemplary embodiment of the present invention;

FIG. 2 illustrates a partial, enlarged cross-sectional view of the electron emission type backlight unit of FIG. 1;

FIG. 3 illustrates a partial, enlarged cross-sectional view of an electron emission type backlight unit according to another exemplary embodiment of the present invention;

FIG. 4 illustrates a partial, enlarged cross-sectional view of an electron emission type backlight unit according to another exemplary embodiment of the present invention;

FIG. 5 illustrates a partial, enlarged cross-sectional view of an electron emission type backlight unit according to another exemplary embodiment of the present invention;

FIG. 6 illustrates a waveform diagram for explaining a method of driving an electron emission type backlight unit according to an exemplary embodiment of the present invention;

FIG. 7 illustrates an exploded perspective view of a liquid crystal display (LCD) device and a backlight unit according to an exemplary embodiment of the present invention; and

FIG. 8 is a partial cross-sectional view taken along line VIII-VIII of FIG. 7.

### DETAILED DESCRIPTION OF THE INVENTION

Korean Patent Application No. 10-2005-0066382, filed on Jul. 21, 2005, in the Korean Intellectual Property Office, and entitled: “Electron Emission Type Backlight Unit, Flat Panel Display Device Having the Same, and Method of Driving the Flat Panel Display Device,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions may be exaggerated for clarity of illustration. It will also be understood that when a layer is referred to as being “on” another layer or substrate, it can be directly on the other layer or substrate, or intervening layers may also be present. Further, it will be understood that when a layer is referred to as being “under” another layer, it can be directly under, or one or more intervening layers may also be present. In addition, it will also be understood that when a layer is referred to as being “between” two layers, it can be the only layer between the two layers, or one or more intervening layers may also be present. Like reference numerals refer to like elements throughout.

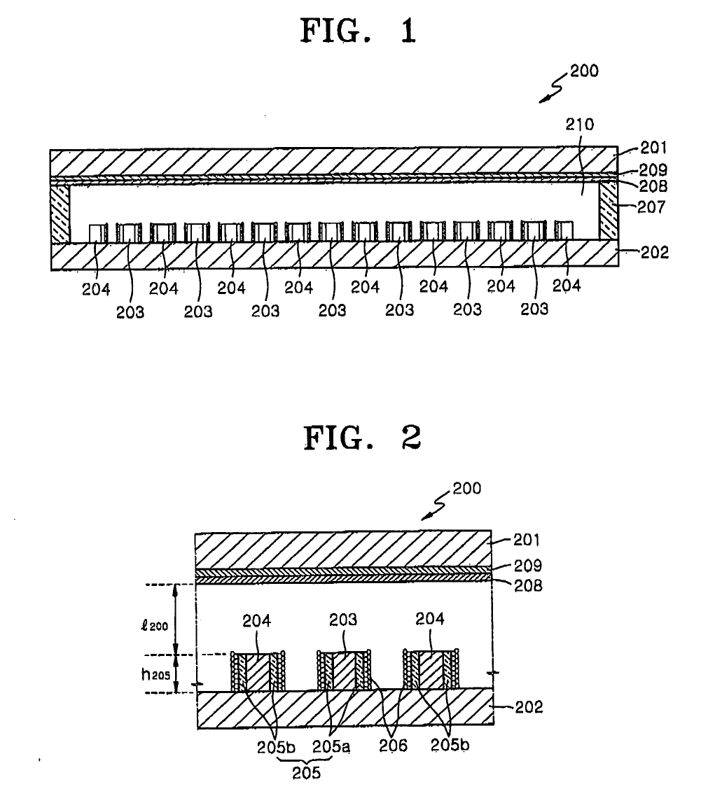

FIG. 1 illustrates a cross-sectional view of an electron emission type backlight unit according to an exemplary embodiment of the present invention. FIG. 2 illustrates a partial, enlarged cross-sectional view of the electron emission type backlight unit of FIG. 1.

Referring to FIGS. 1 and 2, a backlight unit 200 may include a front substrate 201 and a rear substrate 202 that face each other with a predetermined distance between them. An anode 208 and a fluorescent layer 209 may be disposed on a bottom surface of the front substrate 201 facing the rear substrate 202. While FIGS. 1 and 2 illustrate the fluorescent layer 209 disposed between the anode 208 and the front substrate 201, the present invention is not limited thereto, and the order of stacking the fluorescent layer 209 and the anode 208 may be changed. That is, unlike FIG.1 and FIG. 2, the anode 208 may be disposed on the bottom surface of the front substrate 201 and the fluorescent layer 209 may cover the anode 208. In either implementation, the fluorescent layer 209 is excited with electrons so that it may emit visible light.

In accordance with FIGS. 1 and 2, the anode 208 may be, for example, a metal film. Alternately, a transparent electrode composed of, for example, indium tin oxide (ITO) may be formed on a surface of the fluorescent layer 209 and serve as the anode 208. The transparent electrode may cover the entire surface of the front substrate 201 or may be patterned in stripes. Of course, if the transparent electrode is employed, the metal film may be omitted. In an exemplary operation, a specified external voltage, below a withstand voltage, may be applied to the anode 208 in order to accelerate electron beams and increase the brightness of the backlight unit 200.

The rear substrate 202 and the front substrate 201 on which the anode 208 and the fluorescent layer 209 may be formed, may be faced and then may be sealed using a sealant, for example, such as a sealing glass frit, to form the sealed member 207, as illustrated in FIG. 1.

For example, the sealing member 207 may be formed by providing a sealing glass frit in a soft state along an edge of the rear substrate 202 using, for example, dispensing, screen printing, or a similar coating method. Next, water contained in the sealing glass frit may be removed using, for example, a drying process. The rear substrate 202 and the front substrate 201 may be aligned and the sealing glass frit may be sintered at a high temperature so that the sealing member 207 completely seals the rear substrate 202 and the front substrate 201.

FIG. 1 also illustrates an inner space 210, which may be defined between the front substrate 201 and the rear substrate 202. The inner space 210 may be hermetically sealed in a high vacuum state along laminated ends of the front substrate 201 and the rear substrate 202 using the sealing member 207, as discussed above. For example, the inner space 210 may be placed into a high vacuum state by exhausting inner gas through an exhaust port (not illustrated) or the like.

The inner space 210 may be maintained at a pressure of approximately 10⁻⁶ Torr or less. Additionally, the inner space 210 should be maintained in a high vacuum state since particles existing between the front substrate 201 and the rear substrate 202 and electrons emitted from electron emitting layers 205 may collide with each other and generate ions. These ions may cause ion sputtering and may deteriorate the fluorescent layer 209. Also, since electrons accelerated by the anode 208 may collide with residual particles, which may result in a loss of energy, these electrons may not transmit sufficient energy upon collision with the fluorescent layer 209, further resulting in a decrease in luminous efficiency.

An exemplary structure of the backlight unit 200 of an exemplary embodiment will now be explained in detail. Referring to FIG. 2, the rear substrate 202 may be formed of glass or similar material, and the first electrodes 203 may be composed of, e.g., Cr, Nb, Mo, W, and Al, and may be patterned in stripes on the rear substrate 202. However, the first electrodes 203 may be formed of various materials in various shapes, including, e.g., curves and polygons, so long as the first electrodes 203 can freely supply electrons.

A plurality of second electrodes 204 may be formed of a transparent conductive material, such as ITO, IZO, or I₂O₃, or a metallic material, such as Mo, Ni, Ti, Cr, W, or Ag, which may be patterned in stripes on the rear substrate 202. However, the second electrodes 204 may also be formed of various materials in various shapes, including, e.g., curves and polygons. The first and second electrodes 203 and 204 may be alternately arranged on the rear substrate 202. Also, the first and second electrodes 203 and 204 may have the same or substantially the same height, as measured from a common reference point of the surface of the rear substrate 202.

Since electron emission primarily occurs from the opposing side surfaces between the first and second electrodes 203 and 204, electron emitting layers 205a may cover side surfaces of first electrodes 203 adjacent the second electrodes 204 and electron emitting layers 205b may cover side surfaces of second electrodes 204 adjacent first electrodes 203, as illustrated in FIGS. 1 and 2. Accordingly, electron emitting layers 205 that could possibly cover the top surfaces of the first and second electrodes 203 and 204, but would not contribute significantly to electron emission, may be omitted to reduce costs. The secondary electron emitting layers 206 will be discussed in greater detail later.

Electron emitting layers 205 (i.e., electron emitting layers 205a and 205b) may have the same height h₂₀₅ as the first electrodes 203 and the second electrodes 204. The electron emitting layers 205 may be formed of a carbon-based material having a low work function, including, e.g., carbon nanotubes (CNTs), graphite, diamond, diamond-like carbon (DLC), or fullerene (C₆₀). The electron emitting layers 205 may be formed by, for example, thick-film printing a carbon-based paste and then performing a patterning process, for example, through drying, exposure, and development. Alternately, the electron emitting layers 205 may be formed by chemical vapor deposition (CVD), physical vapor deposition (PVD), or other suitable deposition technique.

In an exemplary operation, voltages may be alternately applied to the first electrodes 203 and the second electrodes 204. Thus, the first and second electrodes 203 and 204 may function alternately, so that electrons may be alternately emitted from electron emitting layers 205a covering the first electrodes 203 to the second electrodes 204, and from electron emitting layers 205b covering the second electrodes 204 to the first electrodes 203. This exemplary operation may enhance the stability of electron emission as compared to a unidirectional electron emission structure.

This operation may offer other benefits. For example, the duty cycle or the time taken to apply a voltage to either the first electrodes 203 or the second electrodes 204 may be reduced by half as compared to a unidirectional electron emission structure. Thus, the life of the electron emitting layers 205 may be extended, along with enhanced stability. Further, in contrast to unidirectional electron emission structures, the number of electrons that may be emitted from a section to which no driving voltage is applied may be reduced. Accordingly, this may help reduce unnecessary degradation of the fluorescent layer 209 due to electron sputtering, which may lead to a longer life span of the fluorescent layer 209.

Alternative arrangements of the electron emitting layers 205 may be employed. For example, the electron emitting layers 205 may cover the upper ends of the first electrodes 203 and/or the second electrodes 204. Also, the electron emitting layers 205 do not need to cover a left surface of a leftmost first or second electrode 203 or 204 and/or a right surface of a rightmost first or second electrode 203 or 204, as illustrated in FIG. 1, since these particular surfaces would not contribute significantly to electron emission. Of course, all side surfaces of the first and second electrodes 203 and 204 may be covered by the electron emitting layers 205. Additionally, only the electron emitting layers 205a and the electron emitting layers 205b may be employed, with or without covering an upper end of a corresponding electrode.

The electron emitting layers 205 may be separated by a predetermined distance L₂₀₀ from the stack of the anode 208 and the fluorescent layer 209, so that electrons may be accelerated by an anode field and collide with the fluorescent layer 209 at a sufficient speed to emit visible light.

The secondary electron emitting layers 206 may cover the electron emitting layers 205a, which may be formed on the first electrodes 203 and/or the electron emitting layers 205b, which may formed on the second electrodes 204. The secondary electron emitting layers 206 may be, for example, MgO layers. However, the secondary electron emitting layers 206 may be formed of any material having excellent secondary electron emission characteristics. In an exemplary operation, the electron emitting layers 205a and 205b may generate electrons that may reach the secondary electron emitting layers 206. The secondary electron emitting layers 206, in turn, may generate secondary electrons, whose number is thousand or tens of thousand times the number of the electrons. Thus, electron emission efficiency may be improved.

The secondary electron emitting layers 206 may cover the electron emitting layers 205a, 205b, respectively. However, in an implementation not illustrated, the secondary electron emitting layers 206 may be intermittently disposed to cover only some of the electron emitting layers 205a and 205b.

An exemplary operation of the backlight unit 200 having the above electrode structure will now be explained. First, predetermined voltages may be alternately applied to the first electrodes 203 and the second electrodes 204. When predetermined voltages are applied to the first electrodes 203, electrons may be emitted through the electron emitting layers 205a covering the first electrodes 203. The emitted electrons may be incident on the secondary electron emitting layers 206 covering the second electrodes 204. The complementary cycle may be realized when the predetermined voltages are applied to the second electrodes 204.

Next, a large number of secondary electrons may be generated by the secondary electron emitting layers 206 due to the incident electrons. The electrons, including the secondary electrons, may be accelerated by an electric field generated by the anode 208 that may be disposed on the front substrate 201 to make the electrons collide with and excite the fluorescent layer 209. The excited fluorescent layer 209 may emit visible light while returning to its ground state, and the visible light may be emitted externally through the front substrate 201.

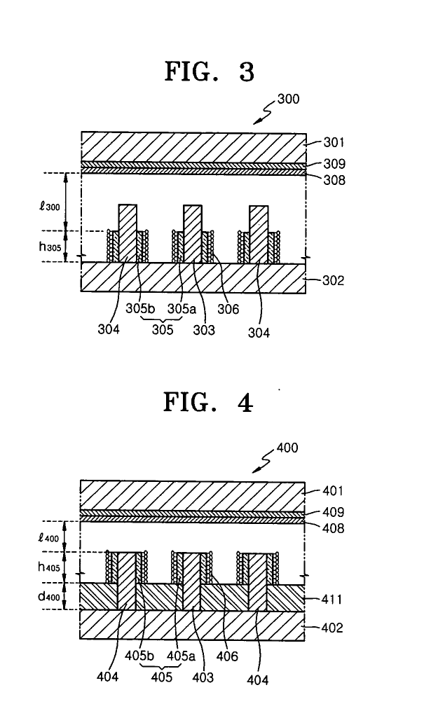

FIG. 3 illustrates a partial, enlarged cross-sectional view of an electron emission type backlight unit according to another exemplary embodiment of the present invention. The backlight unit 300 of FIG. 3 may include a front substrate 301, a fluorescent layer 309, an anode 308, a rear substrate 302, first electrodes 303, second electrodes 304, electron emitting layers 305, which may include electron emitting layers 305a and 305b, and secondary electron emitting layers 306.

In the backlight unit 300, the electron emitting layers 305 may be shorter than the first electrodes 303 and the second electrodes 304. Also, the height h₃₀₅ of the electron emitting layers 305 may be equal or similar to the height h₂₀₅ of the electron emitting layers 205 of FIGS. 1 and 2. That is, the first electrodes 303 and the second electrodes 304 of FIG. 3 may be taller than the first electrodes 203 and the second electrodes 204 of FIGS. 1 and 2.

The first and second electrodes 303 and 304 may improve the blocking of an anode field generated by the anode 308, which may significantly improve the efficiency in controlling electron emission from the second electrodes 304. The electron emitting layers 305a and/or the electron emitting layers 305b may be separated by a predetermined distance L₃₀₀ from the stack of the anode 308 and the fluorescent layer 309, so that electrons may be accelerated by the anode field and collide with the fluorescent layer 309 at a sufficient speed to emit visible light. The secondary electron emitting layers 306 may have the same height h₃₀₅ as the electron emitting layers 305a and 305b, respectively, so as to cover the electron emitting layers 305a and 305b.

FIG. 4 illustrates a partial, enlarged cross-sectional view of an electron emission type backlight unit according to still another exemplary embodiment of the present invention.

The backlight unit 400 of FIG. 4 may include a front substrate 401, a fluorescent layer 409, an anode 408, a rear substrate 402, first electrodes 403, second electrodes 404, electron emitting layers 405, which may include electron emitting layers 405a and 405b, respectively, and secondary electron emitting layers 406. Additionally, insulating layers 411 may also be formed, as will be discussed in greater detail below.

In the backlight unit 400, the electron emitting layers 405 may be separated from the rear substrate 402, by a predetermined distance d₄₀₀, as measured from a common reference point of the surface of the rear substrate 402, and extend to a height equal to or substantially equal to the top surface of at least one of the first electrodes 403 and the second electrodes 402 facing the front substrate 401. The height h₄₀₅ of the electron emitting layers 405 of FIG. 4 may be equal or similar to the height h₂₀₅ of the electron emitting layers 205 of FIGS. 1 and 2.

The first electrodes 403 and the second electrodes 404 may be formed to a height corresponding to or substantially corresponding to the height of distance d₄₀₀ of the insulating layers 411 plus the height h₄₀₅ of the electron emitting layers 405, which may be equal or similar to the height h₂₀₅ of the electron emitting layers 205 of FIGS. 1 and 2, so that a desired electron emission effect may be achieved.

The distance L₄₀₀ between the electron emitting layers 405 and the stack of the anode 408 and the fluorescent layer 409 may be reduced as much as possible, so that the area of the electron emitting layers 405, which contributes to visible light emission, may be maximized. In addition, the first electrodes 403 and the second electrodes 404 may have their heights increased, so that their cross-sectional areas may be increased, which may reduce resistance and may prevent a voltage drop from occurring in a direction perpendicular to the direction of the heights of the first and second electrodes 403 and 404.

Insulating layers 411 may be formed on the top surface of the rear substrate 402 and abut the side surfaces of the first electrodes 403 and the second electrodes 404. The electron emitting layers 405a and 405b and the secondary electron emitting layers 406 may rest on top of the insulating layers 411. Similar to the electron emitting layers 405a and 405b, the secondary electron emitting layers 406 may be separated by the distance d₄₀₀ and may have the same height h₄₀₅ as the electron emitting layers 405. The insulating layers 411 may be formed on the rear substrate 402 and then the electron emitting layers 405a and 405b, as well as the secondary electron emitting layers 406, may be formed on the insulating layers 411. This approach may be simpler in contrast to directly forming the electron emitting layers 405 and the secondary electron emitting layers 406 on the respective side surfaces of the first electrodes 403 and/or the second electrodes 404, without the insulating layers 411 being present.

In this exemplary structure, a strong electric field may be formed between the first electrodes 403 and the second electrodes 404 under the electron emitting layers 405 and the secondary electron emitting layers 406, which may provide a more stable electron emission.

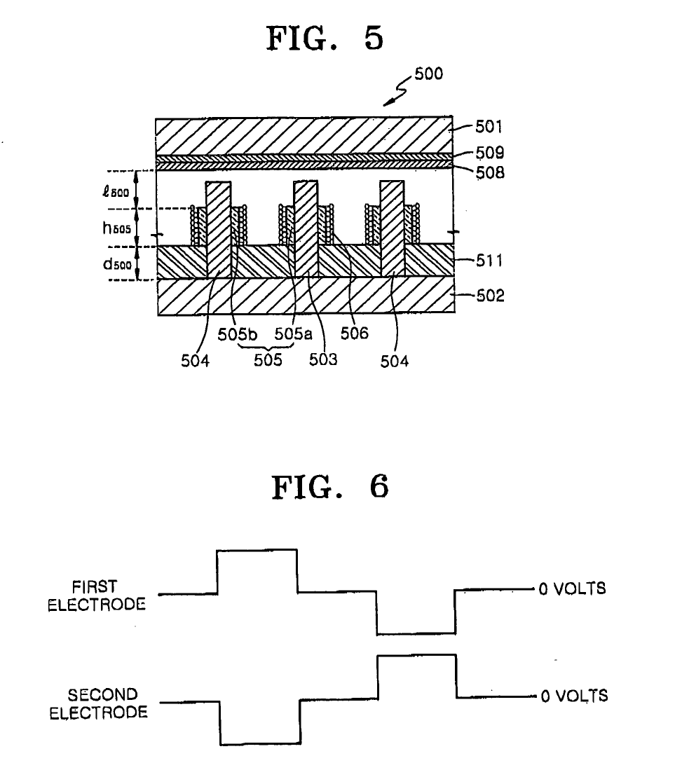

FIG. 5 illustrates a partial, enlarged cross-sectional view of an electron emission type backlight unit, according to yet another exemplary embodiment of the present invention. The backlight unit 500 may include a front substrate 501, a fluorescent layer 509, an anode 508, a rear substrate 502, first electrodes 503, second electrodes 504, electron emitting layers 505 may include electron emitting layers 505a and 505b, and secondary electron emitting layers 506. Insulating layers 511 may also be formed in a manner similar to that discussed above in FIG. 4, regarding insulating layers 411.

In the backlight unit 500, the first electrodes 503 and the second electrodes 504 may be taller than the electron emitting layers 505a and 505b, and the secondary electron emitting layers 506. The electron emitting layers 505a and 505b, and the secondary electron emitting layers 506, may be separated from the rear substrate 502, by a predetermined distance d₅₀₀ as measured from a common reference point of the surface of the rear substrate 502. The height h₅₀₅ of the electron emitting layers 505 and secondary electron emitting layers 506 may not be equal to the height of the top surface of the first electrodes 503 and the second electrodes 504. The height h₅₀₅ of the electron emitting layers 505 and the secondary electron emitting layers 506 may be equal or similar to the height h₂₀₅ of the electron emitting layers 205 of FIGS. 1 and 2.

The electron emitting layers 505a and 505b may be formed to a height corresponding to or substantially corresponding to the height of distance d₅₀₀ plus the height h₅₀₅, so that a desired electron emission effect may be achieved. Thus, the electron emitting layers 505 may be separated from the rear substrate 502 by the distance d₅₀₀ so that the distance L₅₀₀ may be reduced as much as possible, and thus the area of the electron emitting layers 505 that actually contributes to visible light emission can be maximized. Also, the first electrodes 503 and the second electrodes 504 may be formed with additional height, so that the cross-sectional areas of the first and second electrodes 503 and 504 may increase, which may reduce resistance and may prevent a voltage drop from occurring in a direction perpendicular to the direction of the heights of the first and second electrodes 503 and 504.

Also, since the electron emitting layers 505 may cover at least one of the first electrodes 503 and the second electrodes 504, and may not be equal to the height of the top surface of at least one of the first and second electrodes 503 and 504, the first and second electrodes 503 and 504 may improve the blocking of an anode field generated by the anode 508, and may significantly improve the efficiency in controlling electron emission from the second electrodes 504.

In this exemplary structure, a strong electric field may be formed between the first electrodes 503 and the second electrodes 504 under the electron emitting layers 505 and the second emitting layers 506, which may provide a more stable electron emission.

A method of driving a backlight unit according to an exemplary embodiment of the present invention will now be explained with reference to FIG. 6. Referring to FIG. 6, when the electron emitting layers cover both the first electrodes and second electrodes, a positive (+) voltage may be applied to any one of the two electrodes and a negative (−) voltage may be applied to the other electrode. More particularly, positive (+) and negative (−) voltages may be alternately applied to the first electrodes and the second electrodes as illustrated in FIG. 6, such that the electron emitting layers covering the two electrodes alternately emit electrons. Accordingly, the life of the electron emitting layers may be extended, e.g., doubled, as compared to when only specific electrodes may be used as cathode electrodes.

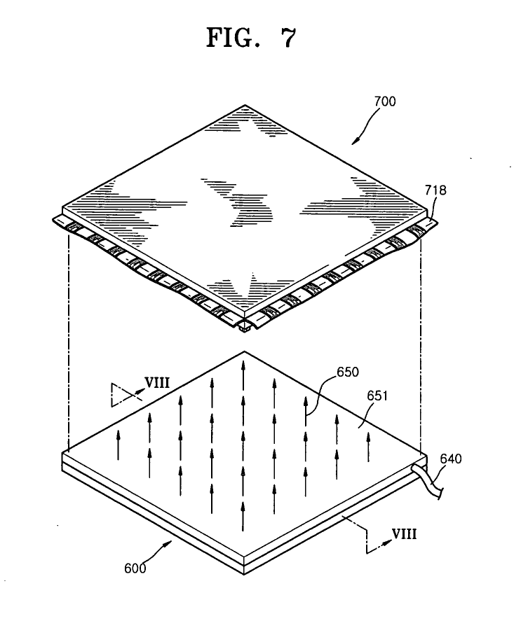

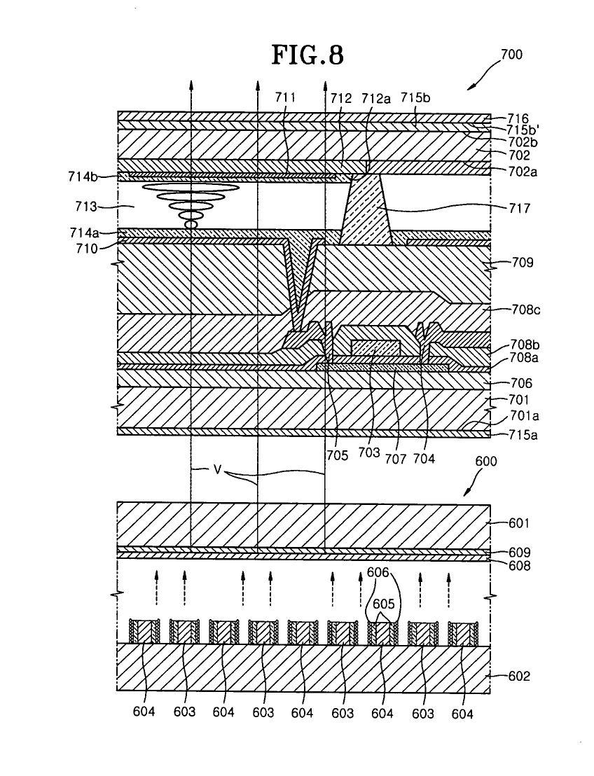

FIG. 7 illustrates an exploded perspective view of a typical liquid crystal display (LCD) device and a backlight unit according to an exemplary embodiment of the present invention. FIG. 8 illustrates a partial cross-sectional view taken along line VII-VII of FIG. 7.

Referring to FIGS. 7 and 8, a LCD device 700 may employ an electron emission type backlight unit 600 to provide light to the LCD device 700. A flexible printed circuit board (PCB) 718 for transmitting an image signal may be attached to the LCD device 700. The backlight unit 600 may be disposed behind the LCD device 700. The backlight unit 600 may receive power through a connecting cable 640 and may emit visible light 650 through a front surface 651 of the backlight unit 600 to the LCD device 700.

Referring to FIG. 8, the electron emission type backlight unit 200 of FIGS. 1 and 2 will be employed for purposes of illustration and discussion only. However, other embodiments of the backlight unit may be employed, including but not limited to each of the backlight units previously discussed above.

The LCD device 700 may be of a generic type and may include a first substrate 701. A buffer layer 706 may be formed on the first substrate 701. A semiconductor layer 707 may be formed in a predetermined pattern on the buffer layer 706. A first insulting layer 708a may be formed on the semiconductor layer 707. A second electrode 703 may be formed in a predetermined pattern on the first insulating layer 708a. A second insulating layer 708b may be formed on the second electrode 703. Next, the first insulating layer 708a and the second insulating layer 708b may be etched by dry etching to expose a part of the semiconductor layer 707, and a source drain 704 and a drain electrode 705 may be formed in a predetermined region including the exposed part of the semiconductor layer 707. Next, a third insulating layer 708c may be formed, and a planarization layer 709 may be formed on the third insulating layer 708c. A first electrode 710 may be formed in a predetermined pattern on the planarization layer 709. The third insulating layer 708c and the planarization layer 709 may be partially etched to form a conductive path between the drain electrode 705 and the first electrode 710.

A transparent second substrate 702 may be separately manufactured from the first substrate 701, and a color filter layer 712 may be formed on a bottom surface 702a of the second substrate 702. A second electrode 711 may be formed on a bottom surface 712a of the color filter layer 712, and a first alignment layer 714a and a second alignment layer 714b facing a liquid crystal layer 713 may be formed on opposing surfaces of the first electrode 710 and the second electrode 711. A first polarization layer 715a may be formed on a bottom surface 701a of the first substrate 701, and a second polarization layer 715b may be formed on a top surface 702b of the second substrate 702. A protective film 716 may be formed on a top surface 715b′ of the second polarization layer 715b. A spacer 717 partitioning the liquid crystal layer 713 may be formed between the color filter layer 712 and the planarization layer 709.

The operation of the backlight unit 600 and the LCD device 700 will now be briefly described. An external power may be applied to the backlight unit 200, an electric field may be formed between the first electrodes 603 and the second electrodes 604, and electrons supplied by the first electrodes 603 may be emitted through electron emitting layers 605 to collide with a fluorescent layer 609 and may generate and emit visible light V to the LCD device 700. In the LCD device 700 will now be explained briefly. A potential difference may exist between the first electrode 710 and the second electrode 711 due to an external signal controlled by the second electrode 703, the source electrode 704, and the drain electrode 705. The alignment of the liquid crystal layer 713 may be determined by the potential difference. Visible light V provided by the backlight unit 600 may be blocked or transmitted according to the alignment of the liquid crystal layer 713. The transmitted visible light V may pass through the color filter layer 712 and radiates color, thereby realizing an image.

While the LCD device 700 in FIG. 8 may be a thin film transistor-liquid crystal display (TFT-LCD), the LCD device 700 is not limited to this implementation and may be any of the various types of non-emissive display devices.

The LCD device 700, employing the electron emission type backlight unit of the present invention, may exhibit improved image brightness, reduced power consumption, and extended life.

As discussed above, the electron emission type backlight unit and the flat panel display device employing the same according to the present invention may have the following advantages. Since the exemplary structures of the first electrodes, the second electrodes, and the electron emitting layers may be improved and the secondary electron emitting layers may be adopted, the effect of an anode field may be effectively blocked and efficiency in electron emission from the second electrodes may be improved.

Since the first electrodes and the second electrodes may be alternately arranged and voltages may be alternately applied to them, unnecessary electron emission may be reduced, which may result in a decrease in power consumption and the deterioration of the fluorescent layer may be reduced, so as to extend the life of the fluorescent layer.

Since the portions of the electron emitting layers which do not contribute to electron emission may be removed, costs incurred due to the electron emitting layers may be reduced.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An electron emission type backlight unit, comprising:
a front substrate and a rear substrate facing each other with a predetermined distance between them;
an anode and a fluorescent layer disposed between the front substrate and the rear substrate;
first electrodes and second electrodes disposed between the front substrate and the rear substrate;
electron emitting layers covering at least one of the first electrodes and the second electrodes; and
secondary electron emitting layers covering the electron emitting layers.

2. The electron emission type backlight unit as claimed in claim 1, wherein the electron emitting layers are partially or entirely covering the at least one of the first electrodes and the second electrodes.

3. The electron emission type backlight unit as claimed in claim 1, wherein the first electrodes and the second electrodes are alternately arranged in parallel on the rear substrate.

4. The electron emission type backlight unit as claimed in claim 1, wherein the first electrodes and the second electrodes have a same or substantially the same height.

5. The electron emission type backlight unit as claimed in claim 1, wherein the electron emitting layers cover side surfaces of the at least one of the first electrodes and the second electrodes.

6. The electron emission type backlight unit as claimed in claim 5, wherein the electron emitting layers have a same height or substantially the same height as the at least one of the first electrodes and the second electrodes.

7. The electron emission type backlight unit as claimed in claim 5, wherein the electron emitting layers are shorter than the at least one of the first electrodes and the second electrodes.

8. The electron emission type backlight unit as claimed in claim 5, wherein the electron emitting layers are separated by a predetermined distance from the rear substrate, and extend to a height equal to or substantially equal to a top surface of the at least one of the first electrodes and the second electrodes.

9. The electron emission type backlight unit as claimed in claim 8, further including insulating layers disposed between the rear substrate and the electron emitting layers, and on portions between the first electrodes and the second electrodes.

10. The electron emission type backlight unit as claimed in claim 5, wherein the electron emitting layers are separated by a predetermined distance from the rear substrate, and extend to a height shorter than a top surface of the at least one of the first electrodes and the second electrodes.

11. The electron emission type backlight unit as claimed in claim 10, further including insulating layers disposed between the rear substrate and the electron emitting layers, and on portions between the first electrodes and the second electrodes.

12. The electron emission type backlight unit as claimed in claim 1, wherein the electron emitting layers include carbon nanotubes.

13. The electron emission type backlight unit as claimed in claim 1, wherein the secondary electron emitting layers are MgO layers.

14. A flat panel display device, comprising:
an electron emission type backlight unit including:
a front substrate and a rear substrate facing each other with a predetermined distance between them,
an anode and a fluorescent layer disposed between the front substrate and the rear substrate,
first electrodes and second electrodes disposed between the front substrate and the rear substrate,
electron emitting layers cover at least one of the first electrodes and the second electrodes,
secondary electron emitting layers covering the electron emitting layers; and
a light receiving device disposed in front of the electron emission type backlight unit, wherein the light receiving device is configured to control light provided by the electron emission type backlight unit in order to produce an image.

15. The flat panel display device as claimed in claim 14, wherein the electron emitting layers are partially or entirely covering the at least one of the first electrodes and the second electrodes.

16. The flat panel display device as claimed in claim 14, wherein the first electrodes and the second electrodes are alternately arranged in parallel on a top surface of the rear substrate.

17. The flat panel display device as claimed in claim 14, wherein the first electrodes and the second electrodes have a same height or substantially the same height.

18. The flat panel display device as claimed in claim 14, wherein the electron emitting layers cover side surfaces of the at least one of the first electrodes and the second electrodes.

19. The flat panel display device as claimed in claim 18, wherein the electron emitting layers have a same height or substantially the same height as the at least one of the first electrodes and the second electrodes.

20. The flat panel display device as claimed in claim 18, wherein the electron emitting layers are shorter than the at least one of the first electrodes and the second electrodes.

21. The flat panel display device as claimed in claim 18, wherein the electron emitting layers are separated by a predetermined distance from the rear substrate, and extend to a height equal to or substantially equal to a top surface of the at least one of the first electrodes and the second electrodes.

22. The flat panel display device as claimed in claim 21, further comprising insulating layers disposed between the rear substrate and the electron emitting layers and on portions between the first electrodes and the second electrodes, where the electron emitting layers are not disposed.

23. The flat panel display device as claimed in claim 18, wherein the electron emitting layers are separated by a predetermined distance from the rear substrate, and extend to a height shorter than a top surface of the at least one of the first electrodes and the second electrodes.

24. The flat panel display device as claimed in claim 23, further comprising insulating layers disposed between the rear substrate and the electron emitting layers and on portions between the first electrodes and the second electrodes, where the electron emitting layers are not disposed.

25. The flat panel display device as claimed in claim 23, wherein the electron emitting layers include carbon nanotubes.

26. The flat panel display device as claimed in claim 14, wherein the secondary electron emitting layers are MgO layers.

27. The flat panel display device as claimed in claim 14, wherein the light receiving device is a liquid crystal display device.

28. A method of driving an electron emission type backlight unit configured to a flat panel display device, the flat panel display device including:
the electron emission type backlight unit, including:
a front substrate and a rear substrate facing each other with a predetermined distance between them,
an anode and a fluorescent layer disposed between the front substrate and the rear substrate,
first electrodes and second electrodes disposed between the front substrate and the rear substrate,
electron emitting layers covering at least one of the first and second electrodes, and
secondary electron emitting layers covering the electron emitting layers; and
a light receiving device that is disposed in front of the electron emission type backlight unit, wherein the light receiving device is configured to control light provided by the electron emission type backlight unit in order to produce an image,
the method comprising:
repeatedly applying a higher voltage to the first electrodes and a lower voltage to the second electrodes for a first period of time, and
alternately, applying a lower voltage to the first electrodes and a higher voltage to the second electrodes for a second period of time, such that electrons are alternately emitted from the electron emitting layers covering the first electrodes and the electron emitting layers covering the second electrodes.

29. The method as claimed in claim 28, wherein a voltage higher than the voltages applied to the first electrodes and the second electrodes is applied to the anode.
